(19) United States
(12) Patent Application Publication
(10) Pub. No.: US 2009/0069454 A1
(43) Pub. Date: Mar. 12, 2009

(54) Component matrix

(75) Inventor: Alison Jane McMillan, Uttoxeter (GB)

Correspondence Address: OLIFF & BERRIDGE, PLC, P.O. BOX 320850, ALEXANDRIA, VA, 22320-4850, US

(73) Assignee: ROLLS-ROYCE PLC, LONDON (GB)

(21) Appl. No.: 12/230,414

(22) Filed: Aug. 28, 2008

(30) Foreign Application Priority Data
Sep. 5, 2007 (GB) 0717204.2

(51) Int. Cl. C08J 9/16

(52) U.S. Cl. 521/56

(57) ABSTRACT

Components formed with a polymer matrix are subject to problems in relation to shrinkage as that polymer matrix cures. With regard to components incorporating reinforcing fibres, such shrinkage may tension and curl the fibres resulting in stresses within the component and premature failure. By providing voids or expandable beads, which alter in size to compensate for volumetric variation in the polymer matrix during curing, such tension may be avoided. Advantageously, the voids or expandable beads have a shape such that there is a reduction in void surface area as the void or expandable bead increases in volume.

The present invention relates to polymer matrixes for utilisation in forming dynamic components such as fan blades and structural components for vehicles, engines and ships.

It is known to form components from polymer materials and in particular polymer materials reinforced with fibres and other elements. Such other elements may include nano particles to improve the various engineering properties of the components such as fatigue resistance. The particles may be comparatively rigid and hollow in order to provide for component weight reduction.

With regard to polymer matrices used as part of fibre reinforced plastics to create components, it will be appreciated that during a curing procedure with respect to the polymer, that the polymer matrix itself tends to change volume: possibly expanding during the chemical process of cure, and shrinking during the cooling process which follows, and usually resulting in a net shrinkage over the whole process. Mostly, this shrinkage is restrained by reinforcing fibre stiffness, and where applicable mould shapes. It will be understood that curing polymer shrinkage occurs as a result of molecular changes in the polymer as it transforms from a liquid amorphous mass to a more stabilised solid. Furthermore, it will be understood that the curing process is often performed at elevated temperatures. Additionally, the curing process itself is exothermic in that heat is given out by the polymer during the transformation from a liquid to a solid state. As the component cures and cools residual tensile stresses are built up within the component, which can then lead to compressive residual stresses particularly at the surface and within the fibres of the component. Tensile residual stresses can lead to matrix cracking and leave the component susceptible to early tensile or fatigue failure. As the fibres in the component are string-like it will be appreciated that the fibres are substantially stiffer in tension than in compression. Compressive residual stresses within the fibres will result in them buckling in situ leading to reductions in component stiffness and a predisposition by the fibres to failure in bending. It will also be understood a component is usually held under pressure during a resin infusion stage (if made by Resin Transfer Moulding or a similar process), and for the curing stage. The level of applied pressure can be varied deliberately, and may give some control over the residual stresses which result from the overall processing.

Improvements in component life and performance are continuing design objectives.

In accordance with the present invention there is provided a matrix for a cured component, a component including such a matrix, and a method of forming such a component as set out in the claims.

Embodiments of aspects of the present invention will now be described by way of example with reference of the accompanying drawings in which:—

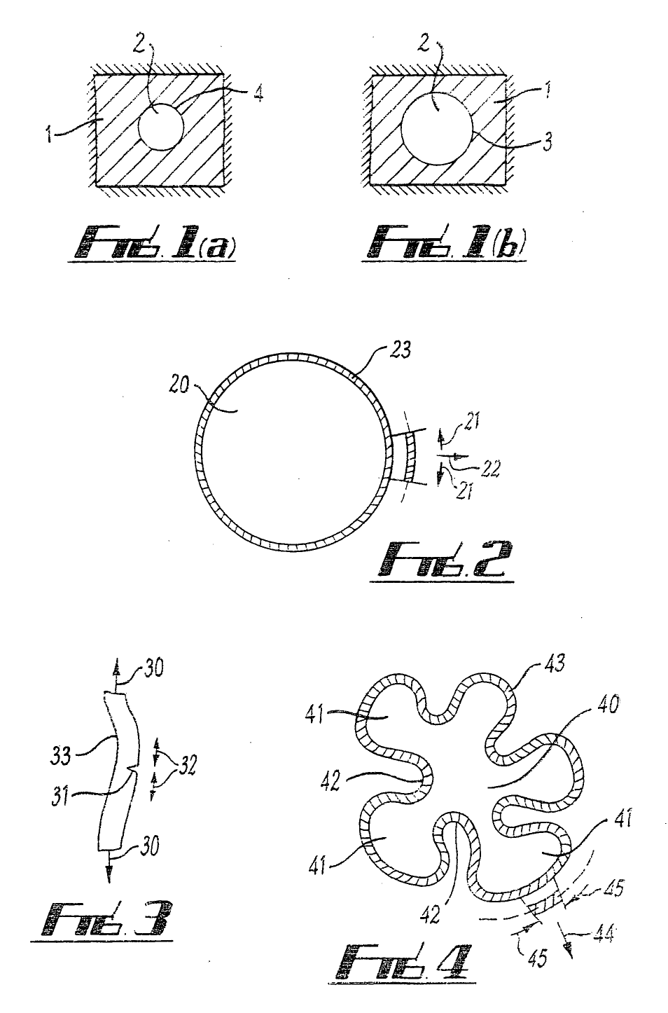

FIG. 1 is a schematic illustration of changes in a matrix between an uncured state and a cured state;

FIG. 2 is a schematic illustration of an expandable void or bead in accordance with aspects of the present invention;

FIG. 3 is a schematic illustration of a membrane as part of the void or expandable bead in accordance with aspects of the present invention; and;

FIG. 4 is a schematic illustration of an expandable bead in accordance with aspects of the present invention.

As indicated above, polymer materials used as a matrix for forming components tend to shrink during curing processes. In such circumstances in accordance with aspects of the present invention, a polymer matrix is filled with expandable beads to act as voids, which expand as the polymer matrix material contracts and shrinks whilst curing. In such circumstance, this contraction can be matched by expansion in the voids, to create a void, or to achieve desired polymer stressing in the component. In terms of matching, it will be appreciated that relative expansion of the beads as expandable beads may substantially equate to that of the contraction of the polymer matrix, or be proportionally less or proportionally greater in order to create a desired pre-tension or pre-compression of a component to adjust the mechanical responsiveness of the component in use.

FIG. 1 provides a simplistic schematic illustration of operation of voids or expandable beads in accordance with aspects of the present invention. One void is depicted but normally there will be large numbers of very small voids in the polymer matrix. In FIG. 1a an initial uncured polymer matrix 1 surrounds a void or expandable bead 2. FIG. 1b illustrates the polymer matrix 1 subsequent to curing. The matrix 1 has contracted in FIG. 1b and typically, as a result of the curing process, releases heat energy in an exothermic action. Once the heat from the exothermic action has been released, the matrix 1 is either naturally or force cooled to retain an expanded figuration 3 for the void or the expandable bead 2. In such circumstances as shown schematically essentially the size of the matrix 1 is retained despite the contraction of the polymer matrix 1 as a result of curing. The matrix surface 3 of the void or expandable bead 2 has increased significantly over the surface 4 of the void or expandable bead 2 as depicted in FIG. 1 a. It sill also be noted that there will only be gradual expansion of the voids in response to contraction due to curing.

The void 2 as depicted in FIG. 1 is substantially spherical but in such a configuration the void 2 is not optimised. A simple spherical void or sphere as will be known expands and contracts with the smallest surface area to volume change of any geometric shape. In such circumstance the membrane of the void needs to be disproportionably extended in comparison with other configurations for the void or expanded bead 2.

FIG. 2 provides a more detailed illustration of a spherical void 20 with a membrane 23. The void 20 is shown under inflation or expansion. Arrowheads 21 indicate the expansion and therefore tension in the membrane 23 as a result of expansion in the direction of arrowheads 22.

From FIG. 2, it will be appreciated that, if the void or expandable bead 20 is in the form of a spherical bubble, then the surface area might simply be in the form of a polymer matrix meniscus. Alternatively, the voids in accordance with aspects of the present invention may be created by hollow or filled beads of some other material. In such circumstances, the material within the bead 20 can be matched or chosen to provide a desired response to the volumetric changes of the polymer matrix as it cures. In any event, as the bead 20 (void) expands, the material, whether that be a gas or liquid or solid, within the bead 2 will expand, or contract, causing tension or compression in the membrane 23. The membrane 23 may be adhered to a surrounding polymer matrix, which may cause further strain and so increase the possibility of cracking or bursting. Clearly, a burst void or expandable bead 20 will not be able to fulfil a duty of expansion and contraction to match volumetric variations in a curing polymer matrix. However, as will be described later, if the material within the void or expandable bead 20 is appropriately chosen, this material may act as a bonding or repair agent for cracks within the as yet not fully cured matrix of a component, in accordance with further aspects of the present invention.

As indicated above, the membrane 23 may be arranged to adhere to the polymer matrix, or can be effectively a meniscus and so float within the uncured matrix. Such possible movement within the matrix may be utilised to concentrate voids or expandable beads if the component formed by the polymer matrix is manipulated whilst still in a relatively flaccid uncured state. Furthermore, the voids or expandable beads may be distorted for asymmetric tensile responses in the component once formed. The mobility of the voids or expandable beads can be adjusted by choices of the density of the material held within the void or expandable bead relative to the polymer matrix. Clearly, solids will tend to have a greater density (and a similar density to the as yet uncured matrix) compared to gases within the void or expandable bead 20, and so may be less responsive being less bouyant.

As indicated, the expandable beads or voids 20 can include solids, liquids or gases which will be chosen to expand or contract during the curing process with regard to the surrounding polymer matrix. This polymer matrix will typically generate heat through an exothermic process or the whole polymer matrix be cooled such that the desired variation in the volume of the void or expandable bead is chosen to match the curing contraction or otherwise. In such circumstances, the void or expandable bead can be configured with the contents chosen, such that there is expansion on cooling as indicated. However, such a response is rare in normal materials but can be achieved through structural materials, or by arranging the contents of the void to have a lower stiffness relative to the polymer matrix material so that it acts as a preferential compression space within the matrix. It will be understood that use of a fluid, such as a gas or liquid, rather than a solid avoids any problems of shear stress. Furthermore, use of a gas rather than a liquid means that stiffness in the void or expandable bead is relatively low.

In view of the above, it will be appreciated that cracking in the membrane of the void or expandable bead, in accordance with aspects of the present invention, may be detrimental. FIG. 3 provides a schematic illustration of a portion of a void membrane 33. In such circumstances, when the membrane 33 is subject to tension in the direction of arrow heads 30, it will be understood that a crack 31 will be subject to tensioning in the direction of arrow heads 32, which will tend to open the crack 31 resulting in the membrane rupturing. As indicated above such rupturing may be beneficial if release of ‘repair’ fluid or other agent can occur in order to repair stressing within the component and in particular the polymer matrix. Nevertheless, in accordance with aspects of the present invention, such membrane rupture will be detrimental in that the void/bead volumetric variation to accommodate volumetric variations in the polymer matrix will no longer be possible subsequent to cracking of the membrane wall.

In view of the above, in the preferred embodiment in accordance with aspects of the present invention, voids or expandable beads are provided in a shape that reduces in its surface area as the void or expandable bead increases in volume. In such circumstances, the void or expandable bead has a lobed, folded or wrinkled configuration similar to some forms of amoeba. FIG. 4 provides an exaggerated schematic cross section of a void or bead 40 defined by a membrane 43. As can be seen, the membrane 43, in its contracted state as depicted in FIG. 4, has a number of lobes 41 defined by folds or wrinkles 42 in the membrane 43. In such circumstances, as the void or bead 40 expands in the direction of arrow heads 44, these lobes 41 accommodate the expansion such that the surface is pivoted and flexed about the folds 42, such that furthest most peripheral surfaces of the membrane 43 are flexed in the direction of the arrow heads 45, reducing tension or causing compression in the membrane 43. A membrane in reduced tension or compression will be more resistant to crack formation and fatigue. The membrane 43 is sufficiently flexible to allow such manipulation. Where the membrane 43 is simply a meniscus skin in the matrix, that skin is flexible to allow manipulation on expansion. It is possible that the void or bead may be created by an initial bead, having a membrane to retain a gas or liquid, where the membrane is subsequently dissolved into the matrix to leave a liquid or gas bubble suspended in the matrix.

As indicated above, the folds 42 and lobes 41 are exaggerated in FIG. 4, and generally more subtle finer wrinkles will be provided in the nominal membrane 43. The membrane 43 may create an effectively dimpled, undulating or fluted “spherical” surface. In such circumstances, such undulations or fluting in the enclosing membrane surface will as described above will respond to expansion such that tensioning in the surface of the membrane is reduced.

By aspects of the present invention, through choosing the appropriate shape for a level of expansion or contraction in the void or bead 40, it is possible to ensure that certain parts of the surface of the membrane 43 are in effect under compression. Such a condition will have significant advantages with regard to functionality of a component formed from a matrix in accordance with aspects of the present invention. Generally, it is possible through an appropriate choice of the membrane material, in terms of stiffness and thickness, to ensure that the membrane essentially remains in compression and at least limited tension, and therefore susceptibility to crack initiation and fatigue crack growth and rupture is avoided in most situations.

It will be understood that, in a practical component formed with a matrix in accordance with aspects of the present invention, reinforcing fibres will be combined with the polymer matrix and expandable beads, defined by membranes or meniscus within the matrix material. The voids or expandable beads will tend to arrange themselves under the influence of pressure, fluid flow of pre-cured matrix material, and perhaps with encouragement such as vibration or ultrasonic shaking. Possibly, the voids or beads will locate between the reinforcing fibre tows, in order to expand and contract, as indicated for volumetric variation in the polymer, and avoid stressing within the component other than as desired. In such circumstances, the component will be formed in accordance with a method, whereby a polymer matrix is combined with expandable beads or voids in an appropriate proportional relation. The number or proportion of expandable beads or voids, and their sizes, will be chosen in relation to the polymer used and operating/curing conditions. Generally, the expandable beads or voids will be of a few nanometres in dimension and therefore large numbers of such expandable beads or voids will be located within the component.

Initially, the polymer matrix will be combined with the expandable beads/voids and mixed to create a desired distribution within the matrix. The combination of polymer matrix along with expandable beads/voids will then be combined with reinforcing fibres and the whole shaped or moulded to a desired component configuration. The curing process will then be performed. The expandable beads or voids will accommodate and compensate for the volumetric variation of the polymer during curing, to achieve the desired retention of size and/or a void tension/compression within the component once fully formed. Typically, the expandable beads and voids will utilise the exothermic reaction as the polymer matrix cures, to trigger expansion or contraction of the expandable beads or voids, to compensate for volumetric variation of the polymer during curing.

Components, in accordance with aspects of the present invention, can have similar configurations to those conventionally formed using typical moulds and other procedures.

By aspects of the present invention a polymer matrix is achieved which has properties in relation to stiffness, fracture toughness and fatigue resistance, which are improved over prior materials. Furthermore, component manufacture is generally simplified in that it is easier to achieve component shapes without shrinkage. In particular, components, which are thick in all three dimensions, are most likely to suffer from shrinkage problems and will be most responsive to aspects of the present invention. Thin components can compensate more easily by shrinking preferentially in the thin dimension and in doing so suffer least stress/strain. Such improvement in productivity aids predictability with regard to manufacturing processes and more consistent production. As there is greater consistency of component manufacture it is likely that there will be a superior manufacturing quality control by reduction of incidents of matrix cracking, fibre waviness or bending of the reinforcing fibres due to tension.

By achieving a component that has material properties which are more consistent and predictable, it will be understood that during design phases, the necessity of accounting for variability will be less of a requirement and therefore greater certainty of usage of the component will be achieved. Furthermore, it will be easier to validate material performance, with reduction of statistical variation in the material during curing processes.

As the volumetric variations in the polymer matrix as it cures will largely be eliminated or controlled, it will be appreciated that local variations with residual stress within the component will also be reduced, meaning that stress analysis of the component can be more accurate. It will be understood, that if residual stress is not taken into account in an accurate fashion, there is a likelihood of a gross error with regard to understanding stress fields within a component. In such circumstances, aspects of the present invention should enable a reduction in the likelihood of failure by unpredicted or unpredictable mechanisms, and so again validation of the component design more easily achieved.

Generally, the voids are expandable beads and, in accordance with aspects of the present invention, will have a lower density than the polymer matrix material, and so reduce overall component weight although only by a proportionally small amount.

Typically, during manufacture, and in order to achieve good polymer matrix wetting and avoid porosity under shrinkage, the liquid polymer matrix will be forced into a preformed tool at high pressure. If shrinkage can be managed by the corresponding void growth, then the pressure of the polymer matrix injection can be lower.

It will be appreciated that even distribution of voids or expandable beads, in accordance with aspects of the present invention, is normally highly beneficial. In such circumstances, the voids or expandable beads should be very small, typically in the order of nanometres in size. In such circumstances, voids or expandable beads can enter into the spaces between reinforcing fibre tows in the regions where matrix material is thickest. It will still be understood that the voids or expandable beads will enter into interstitial spacings between the fibres. With regard to 3D woven composites, it will be understood that the weaving of the reinforcing fibre tows leaves gaps, which can not be filled with fibre. By making voids or expandable beads to an appropriate particle size, it is possible to locate them within these 3D interstitial gaps between the fibres. The particles will generally be quite small with sizes up to 0.5 mm typical, but larger sizes may be used when required. The particles may be of different sizes and ranges of size within a component.

Components, which can be formed in accordance with aspects of the present invention, include fan blades, aeroplane engine propeller blades, helicopter propeller blades, ships and submarine propeller blades. Similarly, static structures can be formed in accordance with aspects of the present invention. With regard to aerospace components, it will be understood that strength, stiffness and reliability or life are critical factors. As aspects of the present invention reduce problems with regard to substantially thick complex shapes formed from fibre reinforced polymer matrix, it will be understood that use of such components in aerospace will become more acceptable.

With regard to sub-sea equipment, where there are requirements in relation to pressure vessels and pipes as well as pipe junction fittings, it will be understood that improvement in performance achieved by materials, in accordance with aspects of the present invention, will have particular benefits.

As indicated above, generally, the voids or expandable beads, in accordance with aspects of the present invention, will be filled with an appropriate material. This material will typically be a fluid, such as a gas or liquid, which contracts or expands as required. Generally, such fluids will have a lower density than the polymer matrix, such that flotation aids or insulation products can be provided. It will be understood, that after a cooling process to remove the exothermic heat after curing, the volume of the component and void/expandable bead is fixed. If the voids or expandable beads are gas filled then the density of these voids or expandable beads is the density of the gas or fluid at the elevated temperature. In such circumstance the gas in the voids or expandable beads are generally rarefied compared to ambient conditions. Such rarefying function will have beneficial effects with regard to a number of situations and will be particularly useful with regard to flotation or thermal insulation as indicated above.

A further benefit with regard to materials and components formed in accordance with aspects of the present invention is in relation to provision of glass fibre components used for radar observation. Carbon fibre or metallic components can be specially coated with a low observable material. As carbon fibres and metals conduct electricity, this can give a tell-tale radar refection.

However, multiple voids or expandable bead carbon fibre composite components, in accordance with aspects of the present invention, may have an improved low observability, as voids can provide regions of multiple reflection of radar signals, to confuse the return signal. Alternatively, the material within the void or expandable bead itself may be arranged to provide absorption of radar signals.

Modifications and alternations in accordance with aspects of the present invention will be understood by those skilled in the art. Thus, as indicated above generally, a void or expandable bead, in accordance with aspects of the present invention, will have a membrane defining lobes with wrinkles or folds such that tension in the membrane is avoided during expansion and contraction, to accommodate volumetric variations in a polymer matrix during curing. Alternatively, the thickness of the membrane may be undulating to provide effective crinkling of the expandable bead surface and so avoid tension within the membrane surface by an in-built pre-compressive structure within the void or expandable bead.

Aspects of the present invention may be used in mass produced products. Early failure of such components may not be safety critical, but avoidance of failure is desirable so as to reduce costs of replacement under guarantee, or to reduce customer irritation. These could be aerospace components or components from any other technological field.

1. A matrix for a cured component, the matrix comprising a polymer and expandable beads to compensate for volumetric variation of the polymer when cured, characterised in that the expandable beads have a folded or lobed peripheral surface.

2. A matrix as claimed in claim 1 wherein the expandable beads are filled with a fluid.

3. A matrix as claimed in claim 1 wherein under predetermined conditions the expandable beads rupture and release a binding fluid to the polymer.

4. A matrix as claimed in claim 1 wherein the matrix incorporates reinforcing fibres or elements.

5. A matrix as claimed in claim 1 wherein the expandable beads utilise thermal action as the polymer cures to provide variable expansion to compensate for volumetric variation of the polymer when cured.

6. A matrix as claimed in claim 1 wherein the expandable beads act as voids within the matrix.

7. A matrix as claimed as claimed in claim 6 wherein the voids provide bubbles within the matrix defined by a surface membrane under tension.

8. A matrix as claimed in claim 1 wherein the expandable beads include materials or structured materials which expand upon cooling.

9. A matrix as claimed in claim 1 wherein the expandable beads have a lower stiffness than the polymer.

10. A matrix as claimed in claim 1 wherein the expandable beads are defined by a membrane.

11. A matrix as claimed in claim 10 wherein the membrane is formed from a material having a stiffness and/or thickness such that membrane tension is controlled during expansion and contraction to compensate for volumetric variation of the polymer when cured.

12. A matrix as claimed in claim 1 wherein the expandable beads have dimensions in a range from in the order of a few nanometres to 0.5 mm.

13. A matrix as claimed in claim 6 wherein the expandable beads are associated with spaces between fibre reinforcement tows within the matrix.

14. A matrix as claimed in claim 1 wherein the expandable beads have a variable internal pressure.

15. A component including a matrix as claimed in claim 1.

16. A component as claimed in claim 15 wherein the component is a fan blade or an aero-engine propeller blade, a helicopter propeller blade or a ship or submarine propeller blade.

17. A method of forming a component comprising mixing a matrix comprising a curable polymer matrix with an amount of expandable beads to match and compensate for volumetric variation of the polymer matrix during curing, characterised in that the expandable beads have a folded or lobed peripheral surface.

18. A method as claimed in claim 17 wherein the method includes incorporating reinforcing fibres or elements in the matrix.

19. A method as claimed in claim 17 wherein the expandable beads utilise thermal action as the polymer matrix cures to provide variable expansion to compensate for volumetric variation of the polymer matrix when cured.
